(19) United States
(12) Patent Application Publication
(10) Pub. No.: US 2012/0291877 A1
(43) Pub. Date: Nov. 22, 2012

(54) GATE VALVE

(76) Inventor: Robert K. Meek, Bakersfield, CA (US)

(21) Appl. No.: 13/472,405

(22) Filed: May 15, 2012

Related U.S. Application Data
(60) Provisional application No. 61/487,266, filed on May 17, 2011.

(51) Int. Cl. F16K 3/30

(52) U.S. Cl. 137/242; 251/328

(57) ABSTRACT

A gate valve including a valve body having a bore there-through, a gate moveable through the bore for blocking and unblocking flow through the bore, a moveable stem coupled to the gate for moving the gate between a first position blocking flow through the bore and a second position not blocking flow through the bore, and a scraper for scraping at least a portion of an outer surface of the stem when the stem is moving for moving the gate.

### CROSS-REFERENCE TO RELATED APPLICATION

The present application claims priority and is based upon U.S. Provisional Application No. 61/487,266, filed on May 17, 2011, the contents of which are fully incorporated herein by reference.

### BACKGROUND

The present disclosure relates to a gate valve, and in an exemplary embodiment to a gate valve for use in high pressures and temperatures such as may be encountered in “huff and puff” oil wells or steam injection wells where steam is used in enhanced recovery operations of heavy oil.

Recovery of heavy oil from the producing zones of subterranean formations often requires enhancement techniques in order to dilute or thin the oil. One of these techniques involves the injection of steam, at temperatures on the order of 600° F., into the formation in order to promote thinning of the heavy oil so that it will flow more easily to the well bore where the product is collected and retrieved. Some wells are cycled back and forth from steam injection to production recovery in a process called “huff and puff”. Asphaltene in heavy oil tends to collect on the interior and operating surfaces of associated equipment, including the seats and gates of valves, especially when the well is shut in after a production cycle and the equipment cools. This collection often impacts the ability of valves to seal or operate properly due to build up of asphaltene, which hardens into a crust-like scale as it cools, on sealing and operating surfaces.

The “headworks”, or bonnet assemblies, of gate valves are impacted by the high temperatures encountered during steaming operations such that lubrication of bearings and operating threads on stems may be compromised. The high temperatures encountered also impact the usual stem packing material used in gate valves used for the subject service.

Two main types of gate valve have customarily been used in the above described operation. The first of these is a gate valve typically referred to as an expanding wedge gate valve which is traditionally used in the field, that is., in the “oil patch.” This type of valve has a non-rising stem with operating threads exposed to the media inside the valve where the buildup of asphaltene affects the operability of the stem. The stem packing is normally re-energized by a semi-plastic material injected into the stem packing area. This material typically loses properties over time and becomes ineffective. Valve seats for interfacing with the gate are normally pressed into pockets within the valve body with inadvertent damage often occurring during installation that leads to leakage between the seat and the valve body pocket. Elastomeric seals are often employed as a means to forestall this undesired bypass leakage, but these are limited to about 450° F. and their demise leads to eventual leakage between the seat and the valve body pocket. The gate is usually of a split parallel segment design that expands during operation to close upon the seat faces and affect a seal. There is a gap between gate segments that often fills with asphaltene during the production mode. This material hardens as stated previously and prevents the gate segments from collapsing during operation, leading to the gate becoming stuck in one position or the other due to lack of operational clearance and requiring unusual and often damaging means to get the gate to move to the desired position. One attempt to overcome this issue is to provide the gate as a slab, but asphaltene buildups again render this arrangement of doubtful benefit due to the clearances necessary in order for the slab gate to move between the seats of the valve.

A second type of gate valve often used in the described service is referred to as a flexible wedge gate such as is typically used in power plants in steam service. The seats of this type of gate valve are positioned at an angle to one another such that a wedge shaped gate is moved in position between them to seal the through passage of the valve. The operator stem is a rising stem such that the operating threads are not exposed to the media within the valve. A stem packing used with this type of valve is of high temperature design and directly re-energizable. However, the rising stem collects asphaltene that affects the performance of the stem packing. Consequently, the flexible wedge gate can become trapped between the seats when in the closed position and become difficult to move to the open position. When the gate is in the open position and producing oil, asphaltene accumulates in the cavities of the valve body as well as the seats and the gate. The gate may become stuck in the open position due to buildup of asphaltene between the gate and corresponding guide vanes cast into the valve body. The through bore of this type of valve is often restricted to a shape and size too small to allow the passage of down-hole tools that service the well.

Both of the described gate valves utilize cast or forged gates of non-uniform cross-sections. Thermal stresses build up due to the irregular shapes that cause the seating faces to distort leading to leakage between the gate and the seat mating sealing faces.

### SUMMARY OF THE DISCLOSURE

In a first aspect, an embodiment provide a gate valve including a valve body having a bore there-through, a gate moveable through the bore for blocking and unblocking flow through the bore, a moveable stem coupled to the gate for moving the gate between a first position blocking flow through the bore and a second position not blocking flow through the bore, and a scraper for scraping at least a portion of an outer surface of the stem when the stem is moving for moving the gate. The scraper is provided to prevent the introduction of asphaltene into the valve stem packing, thus prolonging the stem packing life.

In certain other embodiments, the scraper scrapes the at least a portion of the outer surface of the stem as the stem is moving toward the second position.

In yet another embodiment, the gate valve also includes a stem packing over the scraper, a packing follower over the stem packing, and a packing retainer over the packing follower for retaining the packing follower and the stem packing in a desired position.

In another embodiment, each of the stem packing, packing follower, and packing retainer are annular members and are penetrated by the moveable stem.

In yet another embodiment, the stem packing includes a lattice braided carbon yarn. In another exemplary embodiment, the stem packing includes graphite impregnated yarn. In yet another exemplary embodiment, the packing follower is made from at least one of a brass and bronze.

In certain embodiments, the stem scraper includes a scraping edge extending from a scraper upper body. The scraping edge is included to “peel” asphaltene off of a rising stem to prevent its entry into the stem packing area of the valve

In another embodiment, the stem scraper upper body retains the stem packing in the desired position. The stem scraper provides a second function as the bottom anti-extrusion ring of the stem packing.

In certain embodiments, the gate is coated with a water resistant coating.

In yet another embodiment, the gate valve also includes a bonnet body coupled to the valve body, and the moveable stem moves within a bore within the bonnet body.

In yet another exemplary embodiment, the scraper is located within the bonnet body bore.

In a further embodiment, the stem packing, and at least part of the packing follower are within the bonnet body bore.

In yet a further embodiment, the stem and gate slide linearly for positioning the gate between the first and second positions.

In certain embodiments, the gate valve also includes at least a gate guide mounted on the gate.

In another embodiment, each of the at least a gate guide is wider than the gate.

In yet another embodiment, the gate valve includes two gate guides, each mounted on an opposite sides of the gate, wherein each gate guide interfaces with a corresponding valve seat body mounted on the valve body.

In a further embodiment, the gate valve also includes a first valve seat mounted on the valve body, and a second valve seat mounted on the valve body opposite the first valve seat, such that the gate valve moves between the first and second valve seats between the first and second positions.

In yet a further embodiment, the gate valve further includes a first seat face insert on the first valve seat and a second seat face insert on the second valve seat, and the first seat face insert engages a first surface of the gate and the second seat face insert engages a second surface of the gate opposite the first surface.

In another embodiment the moveable stem includes a hollow portion for receiving a portion extending from the gate for coupling the gate to the moveable stem.

In a second aspect, a gate valve is provided including a valve body having a bore there-through, two opposite valve seats mounted on the valve body, each having an annulus aligned with said bore, a gate moveable between the valve seats and through the bore for blocking and unblocking flow through the bore, and two gate guides mounted on opposite sides of the gate, such that each gate guide interfaces with a corresponding valve seat body mounted on the valve body. The valve seats accommodate thermal expansion and contraction while maintaining continuous contact between the seat faces and the gate. The gate valve provides a full nominal diameter port through a valve and is capable of enduring high operational temperatures while providing effective sealing against a broad range of pressures and media, including asphaltene encountered in heavy oil recovery. The gate valve with the valve seats accommodate small variations in manufacturing tolerances as well as thermal expansion by providing floating hard seat faces. The gate valve has a gate of a slab design and can be manufactured in a slim design to reduce irregular cross-sectional volumes, which virtually eliminates any distortions due to thermal stresses incurred at elevated temperatures.

In certain embodiments, each gate guide is a plate mounted on opposite sides of the gate, and each gate guide is wider than the gate and includes portions extending in opposite directions from opposite surfaces of the gate. The two gate guides are attached to non-sealing sides of the gate and cooperate with the seat bodies so as to guide the gate in its proper path at all times. These guide plates prevent the gate from “sagging” from its proper location regardless of valve orientation and insure that the gate port is aligned with the through bore of the valve body so that unrestricted passage of tools for servicing the well, as well as unrestricted flow through the gate valve, is provided.

In each of the aforementioned exemplary embodiments, the gate may be coated with a wear resistant coating such as a tungsten carbide coating.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

The accompanying drawings facilitate an understanding of the various embodiments.

FIG. 1 is a cross-sectional view of an exemplary embodiment gate valve.

FIG. 2 is a detailed partial cross-sectional view of an embodiment of the valve seat used in an embodiment of the gate valve.

FIG. 3 is a detailed partial cross-sectional view of an embodiment stem scraper used in an embodiment of the gate valve.

FIG. 4 is a partial cross-sectional view of the gate guide plates, gate, and seats depicting exemplary embodiment elements of the valve seats, gate, and the gate guide plates as viewed along arrows 4-4 in FIG. 1.

FIG. 5 is an isometric view of the gate guide plates, gate, and seats showing cooperation between the valve seats and the gate guide plates.

### DETAILED DESCRIPTION

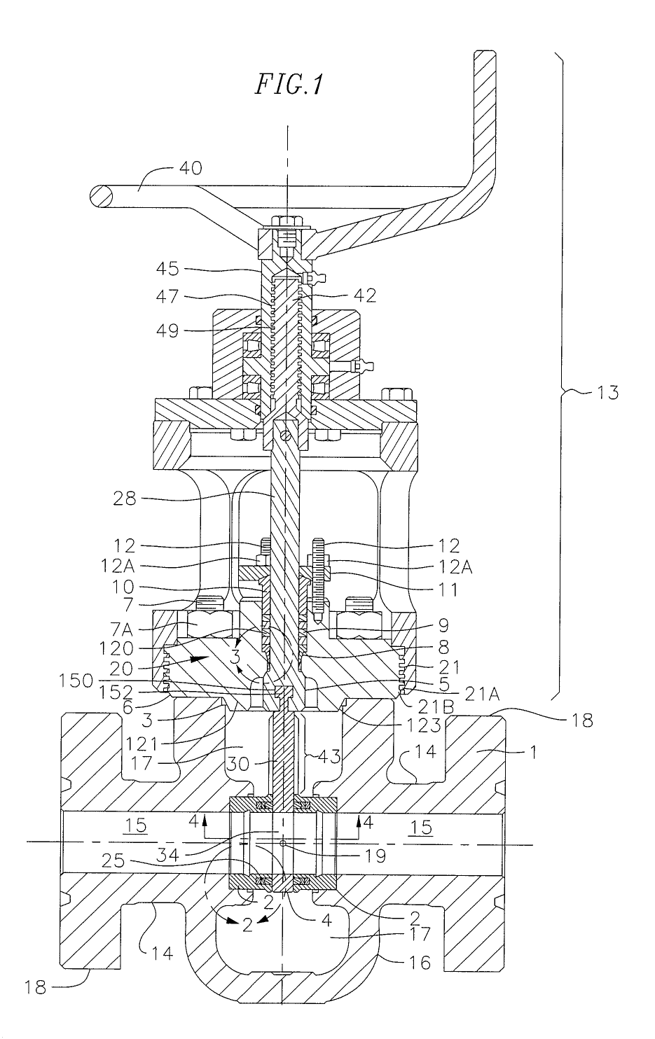

FIG. 1 shows an exemplary embodiment assembly of a gate valve which includes a valve body 1; seat assemblies 2; a gate assembly 4; a valve stem 5; a bonnet assembly 20; a bonnet seal ring 3; and an operator assembly 13. The valve body 1 has a generally cylindrical housing 14 having a diametrical through-bore 15, as well as a perpendicularly intersecting cylindrical housing 16 having a generally diametrical bore or gate cavity 17. The cylindrical housing 14 may have flanged ends 18 or may, alternately, have threaded or butt weld ends (not shown) for interfacing with other equipment. The central axes of the through-bore 15 and the diametrical bore 17 share a common intersecting point, 19. The bonnet assembly 20 mates with the top of the cylindrical housing 16 and is retained to the valve body 1 by a multiplicity of fasteners (for example, threaded studs 7 and nuts 7A). In the shown embodiment, the bonnet assembly 20 includes an annular bonnet body 6 having an annulus 120 which mates with the cylindrical housing 14 covering the diametrical bore 17. The bonnet body 6 has a central projecting portion 121 that is received within the diametrical bore 17. The bonnet assembly 20 is further sealed to the valve body 1 by the seal ring 3 between a periphery 123 and projecting portion 121 of the bonnet body 6 and an inner surface of the diametrical bore 17.

The bonnet assembly 20 also includes, in an exemplary embodiment, a stem scraper 8; a stem packing 9; a packing follower 10; packing retainer 11; and fasteners (for example, threaded studs 12 and nuts 12A), which fasten the packing retainer 11 to the bonnet body 6. In an exemplary embodiment the packing follower 10 is made of brass or bronze. In another exemplary embodiment the stem packing 9 is a lattice-braided carbon yarn. In an exemplary embodiment, each of the stem scraper 8, the stem packing 9, the packing follower 10 and the packing retainer 11 are annular members surrounding the outer surface 28 of stem 5. In the shown exemplary embodiment, the stem scraper 8 and the packing follower 9 are within the bonnet annulus 120 and the packing follower 10 is at least partially within the bonnet body annulus 120. In an exemplary embodiment, each of the stem scraper 8 and stem packing 9 have a close tolerance fit with the stem 5.

The operator assembly 13 is installed onto the bonnet assembly 20 and retained by a threaded connection 21, that is, by being threaded with inner threads 21A formed on an inner surface of the outer assembly 13 to outer threads 21 B formed on an outer surface of the bonnet body 6, or by other suitable means. In other exemplary embodiments, the operator assembly is coupled to the bonnet assembly by other means. In one exemplary embodiment, the operator assembly is integrally formed with the bonnet assembly. For example the bonnet body 6 is integral with the operator assembly. It will be recognized by those practiced in the art that there may be differing configurations of gate valve assembly 1, including elements of seat assembly 2 being integrally provided within the valve body 1 thus eliminating some individual parts of the seat assemblies 2.

Two opposite valve seat assemblies 2 (referred to herein as “seat assemblies”) are installed into corresponding pockets 22 machined into valve body 1 and retained in place by high temperature epoxy 23, as shown in FIGS. 1 and 2. Each seat assembly 2 may also be interference fitted with or without an adhesive, or may be threaded to its corresponding pocket 22. Each seat assembly 2 includes a seat body 24; seat floating face insert 25; and at least a seat face insert seal element or member 26. An exemplary valve seat is disclosed in Provisional Application Ser. No. 61/486726, filed on May 16, 2011, and in an ordinary application entitled “Valve Seat and Valve” claiming priority on said Provisional Application Serial No. 61/486726, filed on even date herewith, the contents of both of which are fully incorporated herein by reference. In an exemplary embodiment, each seat insert 25 is made from a wear resistant material such as a cobalt alloy, including but not limited to cobalt-chromium alloys which may or may not contain tungsten or molybdenum and carbon, such as for example a Stellite® cobalt alloy, tungsten carbide, or machinable ceramics, or combinations thereof. In another exemplary embodiment, each sealing element 26 is made from a material that is capable of retaining their integrity at high temperatures such as, but not limited to, temperatures greater than 450° Fahrenheit. These are materials that retain their volume and sealing properties at such temperatures. For example, the sealing element may be a rope type packing having a lattice style braid and made from carbon graphite yarn. Other packing materials, such as preformed graphite packing materials and flexible graphite materials, as for example, Grafoil® may also be used. More than one type of material may be used to form each sealing element. Moreover, sealing elements formed from different materials may be used in each application.

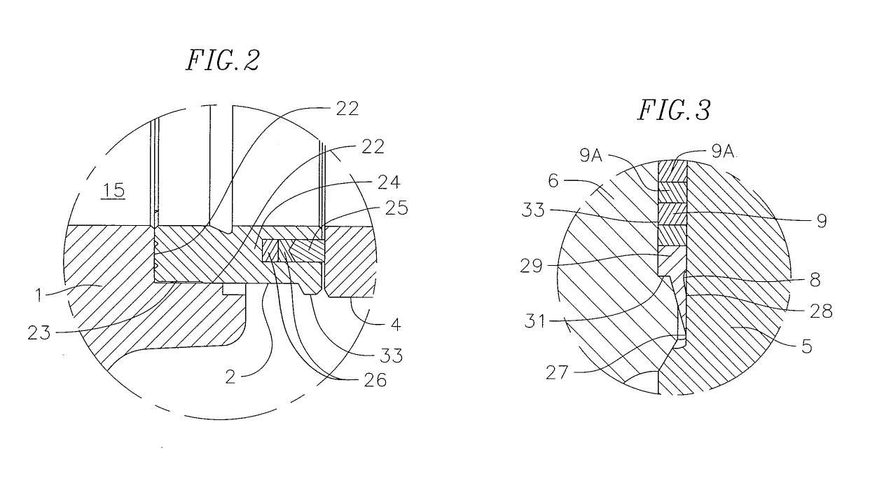

Referring to FIG. 3, the stem scraper 8 has a conical or tapering knife edge 27 that cooperates with stem outer surface 28 of stem 5 to effectively scrape and peel any deposits, such as asphaltene deposits, from stem 5 that may have collected on stem outer surface 28 so as to prevent said deposits from being carried into the stem packing 9. In an exemplary embodiment, the scraper 8 is formed from stainless steel or from other suitable materials. The stem scraper 8 includes a upper body portion 29 that acts as an anti-extrusion device to assist in retaining stem packing 9 in an appropriate location within the bonnet body 6. It supports the stem packing 9 to prevent it from extruding. The knife edge 27 extends from the upper body portion 29. The stem scraper 8 in the shown exemplary embodiment is an annular member and includes an annular conical or tapering knife edge 27, extending from an annular upper body portion 29, for scraping the stem. In an exemplary embodiment, the stem scraper radial clearance with the stem is about 0.004 inch or less and may be not greater than about 0.002 inch.

The stem scraper 8 and packing 9 may be integrally formed as a single member. In an exemplary embodiment the stem packing 9 is an annular member made of a graphite impregnated yarn or other standard stem packing used in the industry such as braided packing. In another exemplary embodiment, the stem packing 9 is formed by a plurality of rings 9A (FIG. 3) one over the other. Each ring may be formed from graphite impregnated yarn or other standard stem packing material. As is shown in FIG. 3, the annular bonnet body 6 forms an annular step 31 onto which is seated the upper body portion 29 of the stem scraper 8. The packing retainer 11 engages and presses the packing follower 10 as the nuts 12A are threaded onto the threaded studs 12. As a result the packing follower 10 engages and presses the stem packing 9, causing the stem packing to engage and press the stem scraper upper body portion 29 against the step 31 of the bonnet. The step 31 prevents the upper body portion of the scraper 29 and thus the scraper 8 from moving further downward relative to the bonnet. The pressure against the stem packing 9 causes the stem packing 9 to form a seal against the bonnet 6 inner surface portion 33.

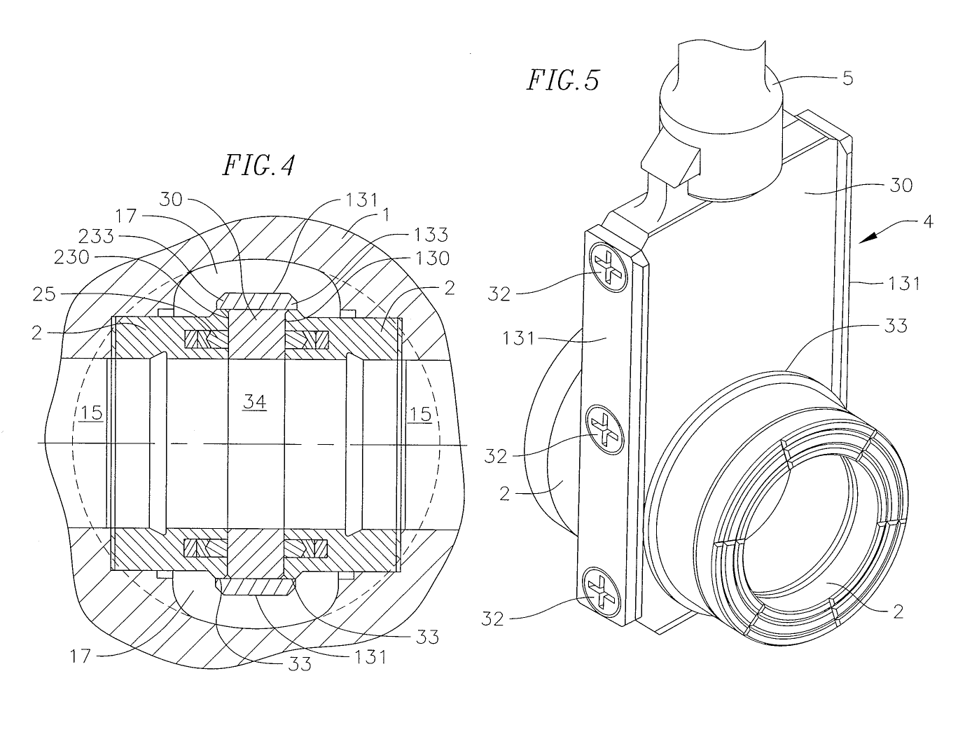

The gate assembly 4 includes a gate 30 which, in an exemplary embodiment, is formed of stainless steel and is provided with a wear resistant coating such as a tungsten carbide coating. The gate 30 includes a through port 34 having an inner surface having essentially the same diameter as the through bore 15. Gate guide plates 131 are fastened to the sides of gate 30 by fasteners 32 and in an exemplary embodiment are made of a corrosion resistant material. The gate guide plates 131 are fastened to the non-sealing sides of the gate, that is, the sides that do not interface with the seat floating inserts of the seat assemblies. In exemplary embodiment, as shown in FIG. 4, each gate guide plate 131 is wider than the gate 30 and has portions 133, 233 extending beyond opposite surfaces 130, 230 of the gate, respectively. The gate guide plate portions 133, 233 cooperate with diametrically raised elements 33 of each seat body 24 to maintain lateral positioning of the gate assembly 4 during movement between open and closed positions, especially so that alignment of the port 34 is maintained with the valve body 1 through bore 15 when the gate 4 is in the open position. The guide plates 131 in another exemplary embodiment may be fastened or otherwise attached to the sides of the gate 30 by other types of fasteners or by using an appropriate adhesive. These guide plates 131 prevent the gate from “sagging” (that is, moving along the direction of bore 15) from its proper location regardless of valve position and ensure that the gate port is aligned with the through bore of the valve body, when the gate 30 is moved into position to allow for flow through its port 34, so that unrestricted passage of tools for servicing the well, as well as unrestricted flow through the bore 15, is provided.

The operator assembly 13 includes a turn wheel 40 coupled to a hollow member 45 having internal threads 47. An upper stem 42 has external threads 49. The upper stem 42 is received in the hollow member such that the internal threads 47 of the hollow member are engaged by the external threads 49 of the upper stem. The upper stem 42 is coupled to the stem 5 which is coupled to an outer surface of the gate 30. The stem includes an inverted annular T-slot 150 that receives an annular T-portion 152 extending from a top end of the gate 30. As the stem couples with an outer surface of the gate, the gate may be made thinner. Conventional gates couple to the stem with a portion of their inner surface. As such conventional gates tend to be thicker so as to have sufficient hollow portion having an inner space to accommodate the stem within them. As a result the thickness through out the conventional gates, is not constant because of their solid and hollow portions, creating thermal stress induced distortions. This is not the case with the exemplary gates, as they can be made thinner because they couple with the stem with an outer surface of a portion extending from one of their ends. As such, the gate 30 incorporated in the gate valve of the present invention can be manufactured in a slim design to reduce irregular cross-sectional volumes, which virtually eliminates any distortions due to thermal stresses which are incurred at elevated temperatures. In an exemplary embodiment, the gate has one third the thickness of conventional gates for the same application. For example, for a 2 inch 5000 psi valve, the gate 30 may have a thickness of about 11/16 inch, which is about one third of the thickness of a slab gate typically used in such an environment.

To close the valve gate, the turn wheel 40 is turned in a direction which causes an upper stem 42 to translate downward and push stem 5 which in turn pushes the valve gate 30 downward into a the gate cavity 17 so that the body portion 43 of the gate moves between seat assemblies 2 into the bore 15 to block flow through the bore. Turning the wheel in the reverse directions causes the upper stem 42 and thus the stem 5 and the valve gate to move upward for aligning the through port 34 of the gate 30 with the bore 15 allowing for flow through the bore 15. The floating seat face insert 25 of each seat assembly interfaces and seals against the gate 30. As the stem 5 moves upward, the outer surface 28 of the stem is scraped by the conical or tapering knife edge 27 of the scraper removing any deposits. The packing retainer 11 retains the packing follower 10; the stem packing 9 and the stem scraper 8 into position as the stem moves axially through the stem scraper.

The gate valve allows for the use of thinner slab gates thereby reducing or eliminating thermal stress induced distortions while minimizing or alleviating the build-up of deposits, such as asphaltene deposits, on the valve stem. Consequently, gate valves of the present invention have longer operating lives than conventional gate valves.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right“, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A gate valve comprising:
a valve body having a bore there-through;
a gate moveable through the bore for blocking and unblocking flow through the bore;
a moveable stem coupled to the gate for moving the gate between a first position blocking flow through the bore and a second position not blocking flow through the bore; and
a scraper for scraping at least a portion of an outer surface of the stem when said stem is moving for moving the gate.

2. The gate valve as recited in claim 1, wherein the scraper scrapes said at least a portion of the outer surface of the stem as the stem is moving toward the second position.

3. The gate valve as recited in claim 1, further comprising:
a stem packing over the scraper;
a packing follower over the stem packing; and
a packing retainer over the packing follower, for retaining the packing follower and the stem packing in a desired position.

4. The gate valve as recited in claim 3, wherein each of said stem packing, packing follower, and packing retainer are annular members and are penetrated by said moveable stem.

5. The gate valve as recited in claim 3, wherein the stem packing comprises a material selected from the group of materials comprising a lattice braided carbon yarn and a graphite impregnated yarn.

6. The gate valve as recited in claim 3, wherein the packing follower is made from at least one of a brass and bronze.

7. The gate valve as recited in claim 3, wherein the stem scraper comprises a scraping edge extending from a scraper upper body.

8. The gate valve as recited in claim 7, wherein said stem scraper comprises an upper body portion for retaining said stem packing in the desired position.

9. The gate valve as recited in claim 1, wherein said gate is coated with a wear resistant coating.

10. The gate valve as recited in claim 1, further comprising:
a bonnet body coupled to the valve body, wherein said moveable stem moves within a bore within said bonnet body.

11. The gate valve as recited in claim 10, wherein the scraper is located within said bonnet body bore.

12. The gate valve as recited in claim 11, wherein the stem packing, and at least part of the packing follower are within said bonnet body bore.

13. The gate valve as recited in claim 1, wherein said stem and gate slide linearly for positioning said gate between the first and second positions.

14. The gate valve as recited in claim 1, further comprising at least a gate guide mounted on said gate.

15. The gate valve as recited in claim 14, wherein each of said at least a gate guide is wider than said gate.

16. The gate valve as recited in claim 1, comprising two gate guides, each mounted on an opposite side of the gate, wherein each gate guide interfaces with a corresponding valve seat body mounted on said valve body.

17. The gate valve as recited in claim 1, further comprising:
a first valve seat mounted on the valve body; and
a second valve seat mounted on the valve body opposite the first valve seat, wherein the gate valve moves between said first and second valve seats between said first and second positions.

18. The gate valve as recited in claim 17, further comprising a first seat face insert on said first valve seat and a second seat face insert on said second valve seat, and wherein the first seat face insert engages a first surface of said gate and the second seat face insert engages a second surface of said gate opposite said first surface.

19. The gate valve as recited in claim 1, wherein the moveable stem comprises a hollow for receiving a portion extending from said gate for coupling said gate to said moveable stem.

20. A gate valve comprising:
a valve body having a bore there-through;
two opposite valve seats mounted on the valve body each having an annulus aligned with said bore;
a gate moveable between the valve seats and through the bore for blocking and unblocking flow through the bore; and
two gate guides mounted on opposite sides of the gate, wherein each gate guide interfaces with a corresponding valve seat body mounted on said valve body.

21. The gate valve as recited in claim 20, wherein each gate guide is a plate mounted on said opposite sides of the gate, and wherein each gate guide is wider than the gate and comprises portions extending in opposite directions from opposite surfaces of the gate.
